(19) United States
(12) Patent Application Publication
(10) Pub. No.: US 2012/0214133 A1
(43) Pub. Date: Aug. 23, 2012

(54) METHOD FOR FABRICATING A CUSTOM IMPLANT ABUTMENT

(76) Inventor: Yunoh Jung, Murray, UT (US)

(21) Appl. No.: 13/033,115

(22) Filed: Feb. 23, 2011

(51) Int. Cl. A61C 5/10; A61C 8/00; B23Q 11/00

(52) U.S. Cl. 433/174; 433/223; 409/131

(57) ABSTRACT

A system and method for fabricating custom implant abutments uses an implant abutment connector to secure a partial blank with respect to a milling tool of a CNC milling machine. The implant abutment connector has an implant interface geometry of an implant. The partial blank can have a prefabricated implant abutment interface geometry of the implant abutment; and can thus mate with the implant, and the implant interface geometry of the implant abutment connector.

### PRIORITY CLAIM/RELATED APPLICATION(S)

This is related to U.S. patent application Ser. No. 12/431,543, filed Apr. 28, 2009; and U.S. patent application Ser. No. 12/431,568, filed Apr. 28, 2009; which are herein incorporated by reference in their entirety.

### BACKGROUND

1. Field of the Invention

The present invention relates generally to a method and a device for milling custom designed dental implant abutments.

2. Related Art

Computer Aided Design and Computer Aided Manufacturing (CAD/CAM) technology has had a big impact on the dental laboratory industry. Dental professionals can use these systems for designing a product and for controlling the manufacturing process. For example, once a dental prosthesis design has been produced with dental CAD software, CAM software controls the machines that construct the final product. The input information regarding the design of the dental prosthesis can either be created directly from the dentist's office based on a patient's intra oral image or can be created in dental laboratories based on a stone model image (or a milled or 3D printed model) which is reproduced by pouring into a dental impression or based directly on the dental impression.

So far, various CAD/CAM systems have been able to make frameworks and/or full contoured dental prosthesis for single crowns, bridges, inlays and onlays as well as custom implant abutments, and temporaries. These various CAD/CAM systems mill materials such as aluminous oxide, zirconium oxide, lithium disilicate glass ceramic, titanium, resin, feldspathic porcelain-based glass ceramics or resin-based composite blocks.

One example of a CAD/CAM made framework and/or a full contoured dental prosthesis in the dental laboratory includes making precise die models and articulated models using conventional modeling techniques which are then photographed with 3 dimensional dental optical scanners. The model is scanned in different positions and the scans are then used to calculate 3D image data. The bite record and tissue areas are also scanned. The data is processed to generate a precise 3D digital representation of the patient's mouth and/or teeth with an average marginal gap of 30 microns or under. Once all the data is calculated and the necessary 3D design of the prosthesis is done by a dental technician, it is transferred to a dental CNC milling machine.

Typical dental CNC milling machines are three dimensional mills that move a rotary cutter through an x, y, z axis envelope. A porcelain based raw material blank can be installed in a chuck or fixture within the envelope and the mill head can be moved around the blank to cut and form the blank into a desired shape. The desired shape is usually programmed into the CNC milling machine controller via a CAM based software program.

In certain situations, a patient's mouth may lack structure to support a dental prosthesis, such as a crown. In such situations, a dental implant can be secured in a hole drilled into the bone in the patient's mouth. An implant abutment is disposed on the dental implant. A coping or crown can then be affixed to the implant abutment. In the case where a coping is secured to the implant abutment, the crown can be secured to the coping. The implant and the implant abutment can be formed of titanium while the coping and crown can be formed of ceramic. A hybrid abutment can be formed of two pieces, namely a bottom of titanium and a top of ceramic.

Some implant abutments, known as stock abutments, can be factory premade. Premade implant abutments have limited ability for modification, namely manual hand grinding to reduce size to make an ideal shape tailored to each patient. Many cases, therefore, require a custom implant abutment. The custom milling of a custom titanium implant abutment can be a difficult and/or expensive proposition since the interface geometry of an implant abutment is of comparatively high precision and must be manufactured within a strict tolerance. Only a high precision, industrial machine can meet the challenge of milling the entire portion of a titanium custom implant abutment composed of the interface geometry, body portion and central hole.

### SUMMARY OF THE INVENTION

There has not been a method or device that would facilitate the precision milling of customized titanium implant abutments within a simplified manufacturing process that can be carried out in the typical dental laboratory or dental office. It has been recognized that it would be advantageous to develop a device, system and/or method for custom milling an implant abutment. In addition, it has been recognized that it would be advantageous to develop a device, system and/or method for milling an implant abutment and a dental prosthetic, such as a crown or coping, on the same milling machine.

The invention provides a method for fabricating a custom implant abutment, the method comprising:
a) securing an implant abutment connector with respect to a milling machine, the implant abutment connector having an implant interface geometry of an implant including a threaded bore;
b) securing a partial blank to the implant abutment connector, the partial blank having a prefabricated implant abutment interface geometry of an implant abutment matable with the implant interface geometry of the implant abutment connector, and having a bore therethrough, by mating the prefabricated implant abutment interface geometry of the partial blank with the implant interface geometry of the implant abutment connector and inserting a fastener through the bore of the partial blank and into securing engagement with the threaded bore of the implant abutment connector;
c) milling a first lateral side of the partial blank with a milling tool of the milling machine to form a portion of a body of an implant abutment in the partial blank;
d) milling a second opposite lateral side of the partial blank with the milling tool to complete the body of the implant abutment in the partial blank, the body and prefabricated implant abutment interface geometry forming an implant abutment securable to an implant; and
e) removing the implant abutment from the implant abutment connector by removing the fastener.

In addition, the invention provides a method for fabricating a custom implant abutment, the method comprising:
a) obtaining an electronic model of at least a portion of a patient's mouth including an implant;
b) creating an electronic model of a body of the implant abutment;
c) obtaining an implant abutment connector secured with respect to a milling machine, the implant abutment connector having an implant interface geometry of an implant including a threaded bore;
d) securing a partial blank to the implant abutment connector, the partial blank having a prefabricated implant abutment interface geometry of an implant abutment matable with the implant interface geometry of the implant abutment connector, and having a bore therethrough, by mating the prefabricated implant abutment interface geometry of the partial blank with the implant interface geometry of the implant abutment connector and inserting a fastener through the bore of the partial blank and into securing engagement with the threaded bore of the implant abutment connector;
e) milling a first lateral side of the partial blank with a milling tool of the milling machine based on the electronic model of the body to form a portion of the body of the implant abutment in the partial blank;
f) causing the partial blank and milling tool to rotate with respect to one another;
g) milling a second opposite lateral side of the partial blank with the milling tool based on the electronic model of the body to complete the body of the implant abutment in the partial blank, the body and prefabricated implant abutment interface geometry forming an implant abutment securable to an implant;
h) removing the implant abutment from the implant abutment connector by removing the fastener;
i) obtaining a subsequent electronic model of at least a portion of the patient's mouth including the implant with the implant abutment secured thereto;
j) creating an electronic model of a crown or coping;
k) securing a dental blank with respect to the milling machine; and
l) milling the dental blank with the milling tool of the milling machine based on the electronic model of the crown or coping.

In addition, the invention provides an implant abutment connector device for securing a partial blank, having a prefabricated implant abutment interface geometry of an implant abutment, to a fixture of a milling machine. The implant abutment connector has a base end removably affixable directly to the fixture or affixable directly to a jig coupled to the fixture. The implant abutment connector has an attachment end having an implant interface geometry matable with the prefabricated implant abutment interface geometry of the partial blank. The implant abutment connector has a threaded bore capable of receiving a fastener through a bore of the partial blank and engaging the threaded bore to secure the partial blank to the attachment end of the implant abutment connector.

Furthermore, the invention provides an implant abutment connector in combination with a partial blank configured to be secured to a fixture of a milling machine. The partial blank comprises a prefabricated implant abutment interface geometry of an implant abutment and a bore therethrough. The implant abutment connector comprises a base end removably affixable directly to the fixture of the milling machine or affixable directly to a jig coupled to the fixture of the milling machine. The connector also comprises an attachment end having an implant interface geometry mated with the prefabricated implant abutment interface geometry of the partial blank. The connector further comprises a threaded bore with a fastener through the bore of the partial blank and engaging the threaded bore to secure the partial blank to the attachment end of the implant abutment connector.

Thus, the current invention solves the above identified challenge by providing a partially milled titanium blank, having a pre-fabricated implant abutment interface geometry to be used to make a custom implant abutment. This type of abutment also has a better fit than conventional custom abutments since the titanium mating surface was manufactured to fit very tightly. Well made dental implants have a very tight connection between the implant and the implant abutment. This can be very important for the long-term maintenance of the bone around the implant.

End users can simply secure this pre-fabricated blank to the holder and mill the custom created body portion of the implant abutment. Therefore, with this device and method it is possible to attain high precision accuracy as well as a shortened fabricated time.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a partially exploded perspective view of a primary fixture removed from a milling machine with an implant abutment connector and a jig secured to the primary fixture in accordance with an embodiment of the present invention;

FIG. 2 is a perspective view of the primary fixture of FIG. 1 shown with respect to a milling tool of the milling machine of FIG. 1 and showing 1) the implant abutment connector being attached and/or removed from the jig, 2) a partial blank being attached to the implant abutment connector, and 3) an implant abutment being removed from the implant abutment connector;

FIG. 3 is a perspective view of the jig of FIG. 1 shown removed from the primary fixture and also showing 1) the implant abutment connector being attached and/or removed from the jig, 2) a partial blank being attached to the implant abutment connector, and 3) an implant abutment being removed from the implant abutment connector;

FIG. 4 is a perspective view of another primary fixture in accordance with another embodiment of the present invention shown removed from the milling machine and shown with respect to a milling tool of the milling machine of FIG. 1 and showing 1) a partial blank being attached to the implant abutment connector, and 2) an implant abutment being removed from the implant abutment connector;

FIG. 5a is an exploded perspective view of the implant abutment connector and the partial blank of FIG. 1;

FIG. 5b is an exploded perspective view of the implant abutment connector and the partial blank of FIG. 1;

FIG. 6a is an exploded perspective view of the implant abutment connector and the implant abutment of FIG. 1;

FIG. 6b is an exploded perspective view of the implant abutment connector and the implant abutment of FIG. 1;

FIG. 7 is a partial cross-sectional perspective view of the partial implant attached to the implant abutment connector attached to the jig of FIG. 1;

FIGS. 8a-c are side schematic views of the partial blank with respect to the milling tool of FIG. 1 showing various aspects of a method of the present invention; and

FIG. 9 is a schematic view showing various aspects of a method of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Definitions

The term “implant” is used herein to refer to all types of dental implants that are affixed in a patient's mount, often to the bone of the jaw. Such implants can provide a structure to which an implant abutment is affixed via an interface geometry.

The term “implant abutment” is used herein to refer to all types of implant abutment structures affixed to the implant and between the implant and a crown or coping. The implant abutment can be a single, monolithic structure, or can be formed by more than one piece. The implant abutment has an interface geometry that matches and/or mates with the interface geometry of the implant.

The term “partial blank” is used herein to refer to a blank of material from which an implant abutment will be milled, machined or fabricated; but which has a prefabricated implant abutment interface geometry that mates with the implant, and a millable blank portion which will be formed into a body of the implant abutment.

The term “coping” is used herein to refer to a substructure disposed on the implant abutment between the implant abutment and the crown.

The term “crown” is used broadly and interchangeably herein to refer to crowns, bridges, copings, etc.

The coping and crown are sometimes referred to as a superstructure or suprastructure.

### Description

The present invention provides a system and method for custom milling or fabricating custom implant abutments using an implant abutment connector to secure a partial blank with respect to a milling tool of a CNC milling machine. The implant abutment connector can have an implant interface geometry of an implant; and can be a pseudo implant or can mimic the implant or interface thereof that receives the implant abutment. The partial blank can have a prefabricated implant abutment interface geometry of the implant abutment; and can thus mate with the implant, and the implant interface geometry of the implant abutment connector. Therefore, the prefabricated implant abutment interface geometry of the partial blank is prefabricated to mate with the implant; while the implant abutment connector uses this same interface geometry to mate with the partial blank to secure and hold the partial blank for milling or fabrication.

The system and method of the present invention, and the implant abutment connector, can allow the partial blank to be milled in the same space or envelope of a CNC milling machine as dental blanks being milled to form crowns and/or copings. Thus, the present invention provides a system and method for milling, or alternately milling, both implant abutments and dental blanks in the same space or envelope of the CNC milling machine. The implant abutment connector can be affixed to either: 1) a primary fixture held by the CNC milling machine (such as in a cavity configured to hold a millable dental blank); 2) a jig held by the primary fixture (such as in the cavity configured to hold the millable dental blank), or 3) a secondary fixture that replaces the primary fixture in the CNC milling machine.

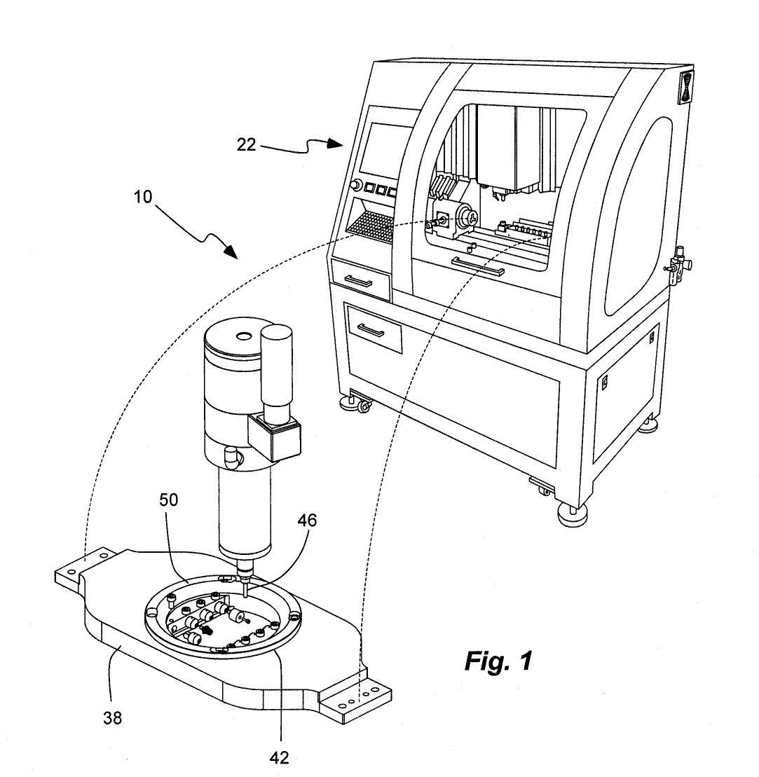

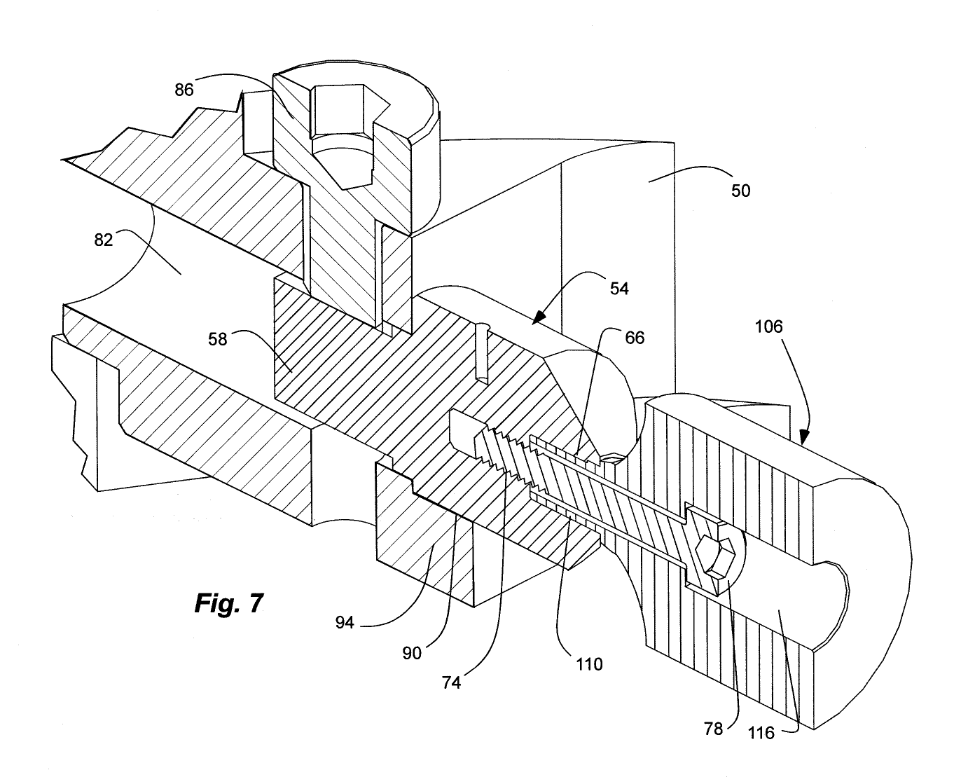

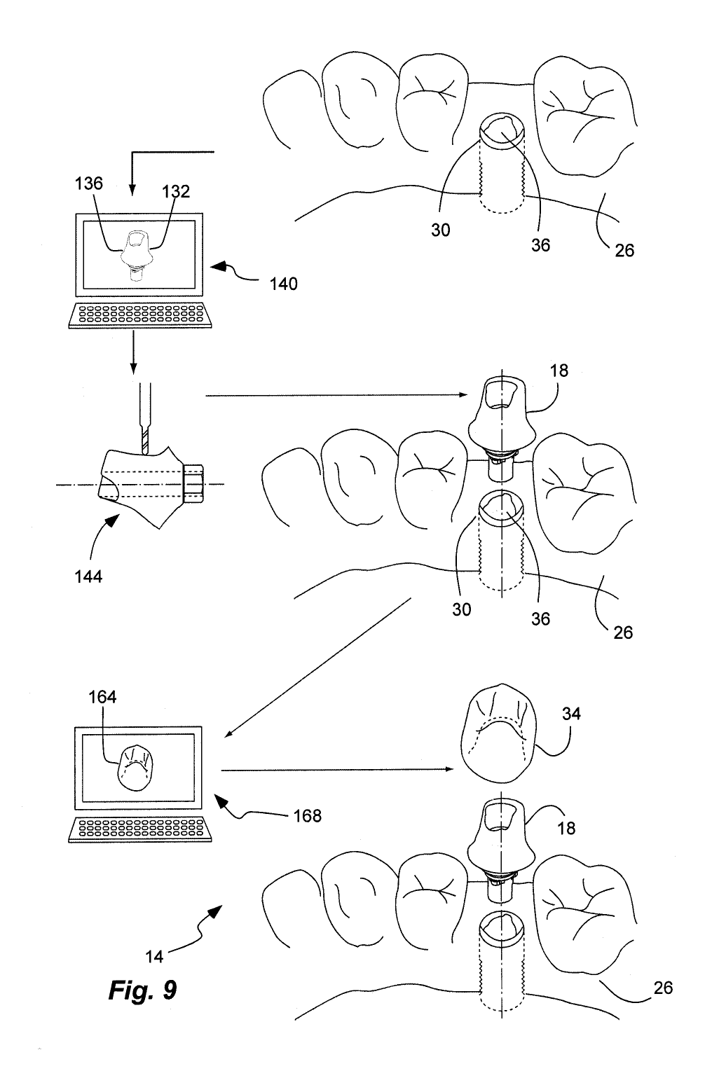

As illustrated in FIGS. 1-9, a system, indicated generally at 10, and method, indicated generally at 14 (FIG. 9), in an example implementation in accordance with the present invention is shown for milling or fabricating custom dental abutments 18 in a CNC milling machine 22. The dental abutments 18 can be received and held in a patient's mouth (indicated by 26 in FIG. 9) by an implant 30 (FIG. 9) or dental implant, and can receive a crown 34 or coping (FIG. 9). The implant 30 is affixed in the patient's mouth 26, such as to the bone of the jaw. The implant 30 has an interface geometry 36 for receiving and securing the implant abutment 18. The interface geometry 36 of the implant 30 can be a shaped cavity or bore, including for example, an upper shaped cavity and a lower threaded bore. Thus, the interface geometry 36 of the implant 30 can include an indentation.

In accordance with one aspect of the present invention, the CNC milling machine 22 can include a primary fixture 38. The primary fixture 38 can be a plate and can have opposite ends to be held in opposite chucks of the milling machine. The milling machine 22 and/or the primary fixture 38 can be configured for or adapted to receiving and holding a millable dental blank (not shown), such as a solid disc of constant material, such as zirconium dioxide, zirconium oxide ceramic, titanium, titanium alloy, acrylic polymer, plastic, wax, etc. The disc can be relatively large, such as 10 cm in diameter, and capable of having several crowns, bridges, copings, etc. milled therein. Thus, the primary fixture 38 can have a round or circular receptacle or cavity 42 therein to receive the disc. The receptacle or cavity can have a lower annular lip against which the large blanks or discs are received. A retaining ring can be secured over the opening or cavity to retain the large blank or disc. The primary fixture can remain in the milling machine while the retaining ring and larger blank or disc are removed and replaced. The milling machine can include one or more chucks or the like for securely holding the primary fixture 38, and one or more cutting or milling tools 46 tools to mill the disc or implant abutment. Thus, the larger millable dental blank received in the primary fixture 38 of the milling machine 22 can be capable of being machined to form a plurality of crowns, bridges, copings, etc.

In addition, an interchangeable jig 50 can be received in the cavity 42 of the primary fixture 38, and held by or carried by the primary fixture 38. The jig 50 can be wholly or partially sized and shaped as the larger millable dental blank so that it is interchangeable with the larger blank in the primary fixture 38. For example, the jig can be round to fit in the round or circular receptacle or cavity 42 of the primary fixture 38. The jig can be annular with a body that fits in the receptacle or cavity 42 of the primary fixture, and an annular flange on one end of the body that can abut to the plate of the primary fixture. The flange can have holes to receive fasteners to secure the jig to the primary fixture. The annular body of the jig can define an open center between an inner lateral face. The jig can be metal and can be formed by machining.

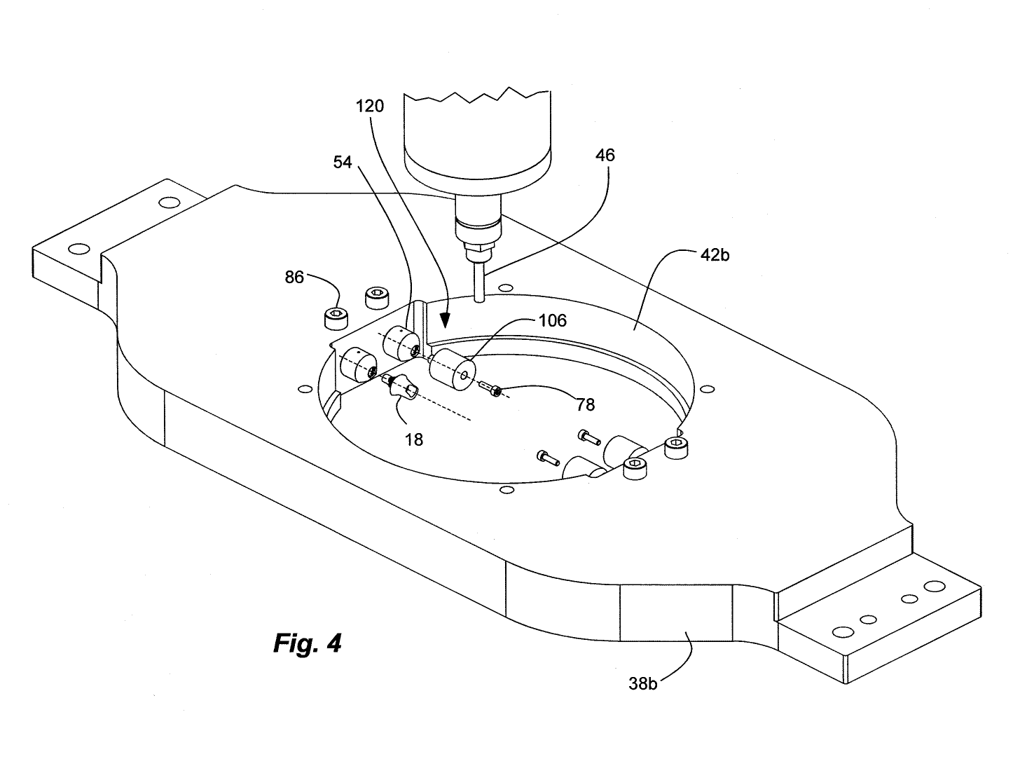

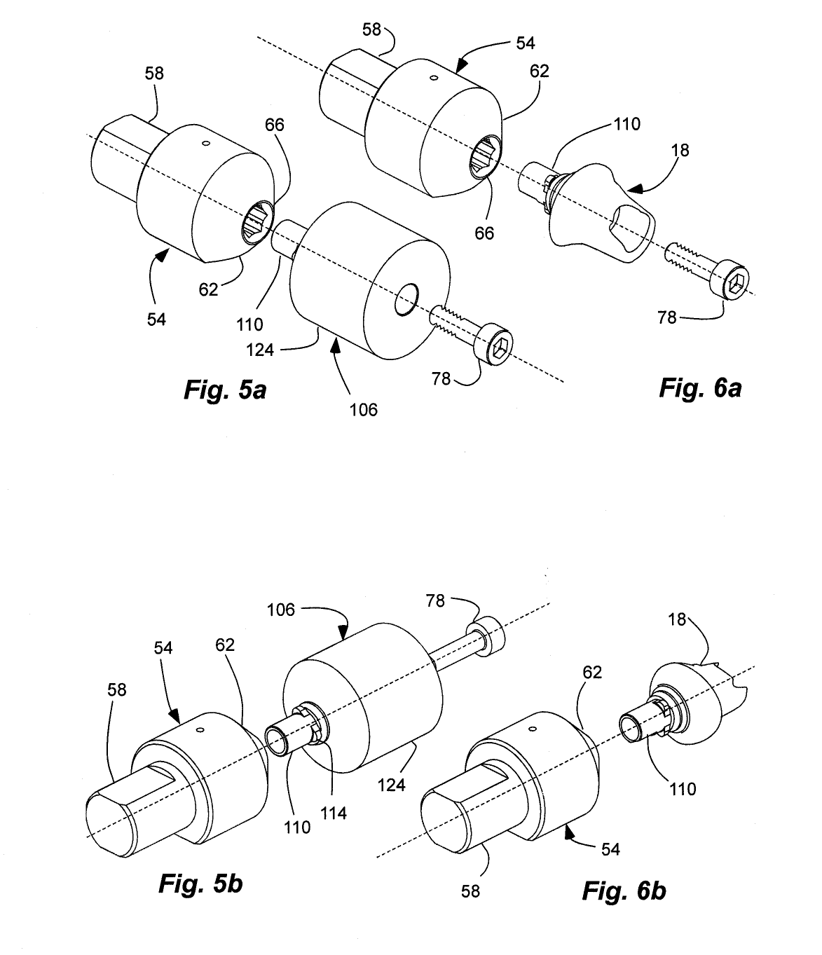

One or more implant abutment connector(s) 54 can be carried by the primary fixture 38. The implant abutment connector 54 can be removably affixed directly to the primary fixture 38, as shown in FIG. 4; or can be removably or permanently affixed directly to the jig 50, which in turn is coupled to and carried by the primary fixture 38, as shown in FIGS. 1-3 and 7. The implant abutment connector 54 can have opposite sides or end, including a base end 58 (FIGS. 5a-7) removably affixed directly to the fixture 38, or affixed directly to the jig 50 coupled to the fixture, and an attachment end 62 (FIGS. 5a-7). The attachment end 62 of the implant abutment connector 54 can have an implant interface geometry 66, essentially the same as the interface geometry 36 of the implant 30. The implant interface geometry 66 of the implant abutment connector 54 can include an outer shaped cavity 70 and an inner threaded bore 74, as shown in FIG. 7. Thus, the interface geometry 66 of the implant abutment connector 54 can include an indentation. The implant interface geometry 66 of the connector 54 essentially mimics the interface geometry 36 of the implant 30. The shaped cavity of both the connector and the implant resists rotation of the implant abutment 18 with respect to the implant 30. The threaded bore 74 of the connector 54 receives a fastener 78, as described in greater detail below.

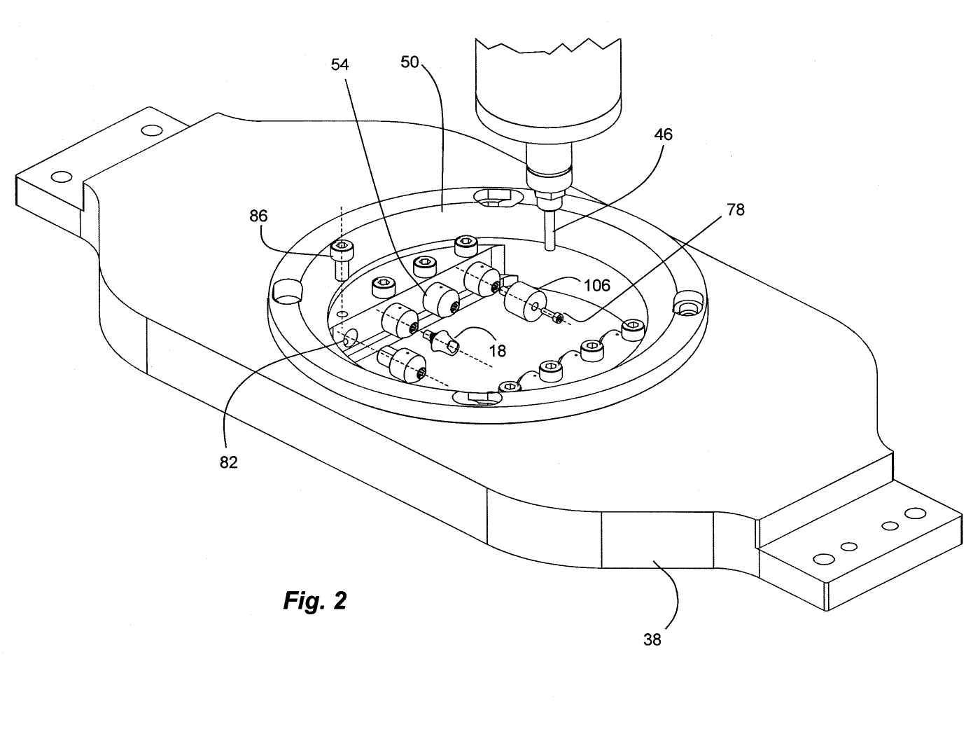

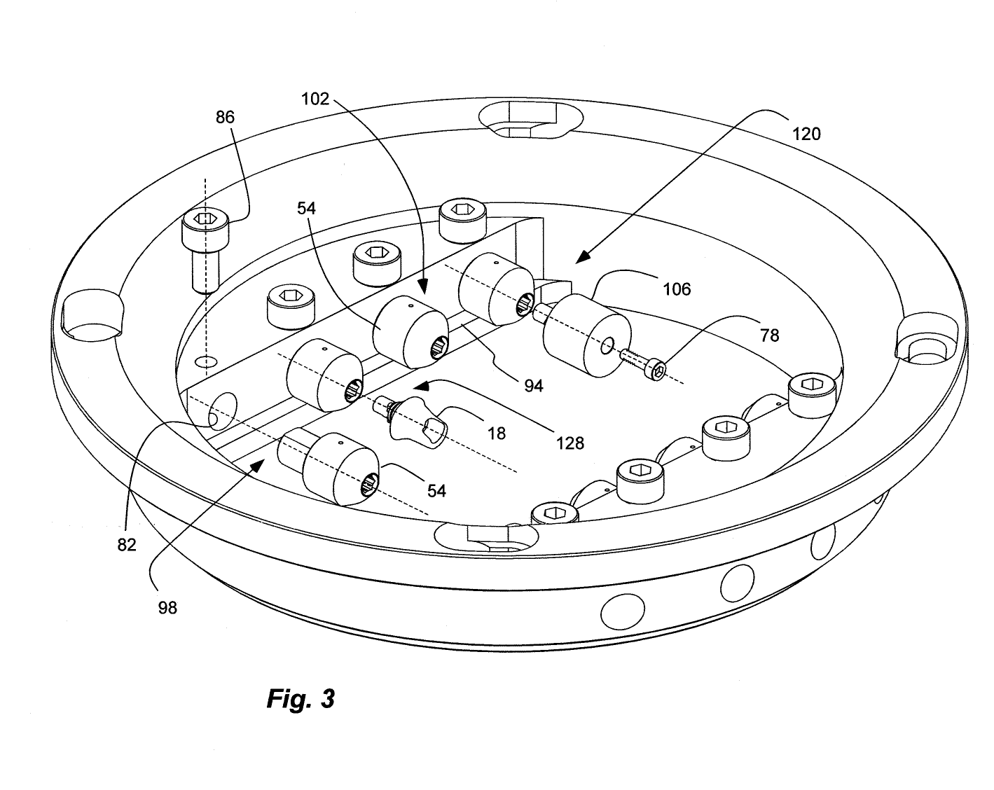

Referring to FIGS. 2, 3 and 5a-6b, the base end 58 of the implant abutment connector 54 can be mostly circular, cylindrical or rod-like to be received in a bore 82 formed in the jig 50 (or in the primary fixture). The jig 50 can have a plurality of bores 82 to receive a plurality of connectors 54. The jig 50 can be annular with the bores 82 on an interior face of the jig. Thus, axes of the bores can be transverse to an axis of the jig or open center thereof. The open center of the jig can have opposing flat faces with the bores therein. The base end 58 can have a flat against which a set screw 86 can abut to retain the base end 58 in the bore 82. In addition, the attachment end 62 of the connector 54 can have a flat 90 that abuts a step 94 in the opposing flat faces to resist rotation of the connector with respect to the jig. A small hole or other indicia can be formed on the attachment end of the connector to indicate proper alignment of the connector with respect to the jig. The connector 54 is shown being attached and/or removed from the jig 50 at 98 in FIG. 3. The connector 54 is shown attached to the jig 50 at 102 in FIG. 3. Removably attaching the implant abutment connectors 54 to the jig or primary fixture allows the implant abutment connects to be replaces as they are worn. The implant abutment connectors can be metal, and can be formed by machining.

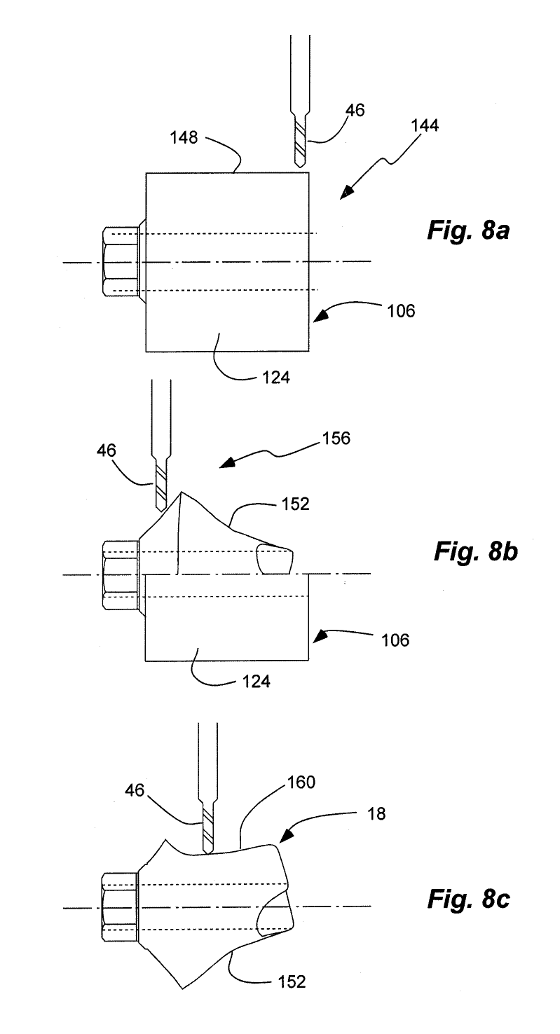

The implant abutment connector 54 in turn can carry and secure a partial blank 106 to the jig 50 and/or fixture 38 with respect to the milling tool 46 of the milling machine 22. The partial blank 106 (FIG. 5b) has a prefabricated implant abutment interface geometry 110 that mates with the interface geometry 36 of the implant 30, and the implant interface geometry 66 of the connector 54. The prefabricated implant abutment interface geometry 110 can have a shaped protrusion 114 that mates or matches with the shaped cavity 70 of the connector 54. The shaped protrusion can have lateral lobes or the like to key with the cavity to resist rotation and cause alignment. Thus, the partial blank can have a male connection with the connector and implant can have a female connection; although it will be appreciated that the opposite configuration is also possible. The partial blank can also have a bore 116 therethrough to receive the fastener 78 and into the threaded bore 74 of the connector 54 to secure the partial blank to the connector, and thus the jig and/or fixture. The partial blank 106 is shown being attached to the connector 54 at 120 in FIG. 3. The partial blank 106 can have opposite ends or sides, including the prefabricated implant abutment interface geometry 110 on one end, and a millable blank portion 124 on the opposite end, which can be cylindrical. The partial blank can be formed of or can include titanium. With the partial blank 106 secured to the connector 54 and fixture 38, the millable blank portion 124 can be milled by the milling tool of the milling machine to form the implant abutment 18. The millable blank portion 124 of the partial blank 106 is shown being milled in FIGS. 8a-c. The milled implant abutment 18 is shown being removed from the connector 54 and fixture and/or jig at 128 in FIG. 3.

Referring to FIG. 4, the implant abutment connector 54 can be directly coupled to the primary fixture 38b, without the intervening jig 50. The primary fixture 38b and/or the receptacle or cavity 42b thereof can include one or more bores 82 to receive one or more connectors 54. For example, the bores 82 can be on an interior face of the primary fixture 38b, such as in opposing flat faces, with the axes of the bores transverse to an axis of the open center. A set screw 86 can abut to retain the base end 58 in the bore 82. Thus, primary fixture 38b itself can secure both dental blanks and the implant abutment connector(s) 54 and the partial blank(s) 106. Alternatively, a secondary fixture, configured to hole the implant abutment connector(s) 54 and the partial blank(s) 106, can be interchangeable with the primary fixture. The secondary fixture can be configured similar to the primary fixture shown in FIG. 4, but could have a different shaped cavity.

Securing the implant abutment connectors 54 to the jig 50 or the primary fixture 38 allows the primary fixture 38 to be used to secure both partial blanks 106 for fabricating custom implant abutments 18, and dental blanks for fabricating crowns 34 or copings. In addition, the same milling machine 22 can be used to fabricate both implant abutments 18 and crowns 34 or copings.

A method of using the above described system and the implant abutment connector 54 to fabricate a custom implant abutment 18 can include securing the implant abutment connector 54 with respect to the milling machine 22 and/or milling tool 46 thereof; or obtaining an implant abutment connector 54 secured with respect to the milling machine. As described above, the implant abutment connector 54 can be secured with respect to the milling machine 22 by affixing the connector directly to the primary fixture 38b (FIG. 4), or directly to the jig 50 held by the primary fixture 38 (as shown at 98 in FIG. 3). The base end 58 of the implant abutment connector 54 can be inserted into the bore 82 in the jig 50 or primary fixture 38b and secured with the fastener 86. The flat 90 of the implant abutment connector 54 can abut the step 94 in the jig to resist rotation of the connector with respect to the jig. The implant abutment connector 54 can have the implant interface geometry 66 of the implant 30 and the threaded bore 74.

The partial blank 106 is secured to the implant abutment connector 54 by mating the implant abutment interface geometry 110 (FIG. 5b) of the partial blank 106 with the implant interface geometry 66 (FIG. 5a) of the implant abutment connector 54, and inserting the fastener 78 through the bore 116 of the partial blank 106 and into securing engagement with the threaded bore 74 of the implant abutment connector 54, as shown at 120 of FIG. 3. The partial blank 106 has the prefabricated implant abutment interface geometry 110 of the implant abutment 18 that is matable with the implant interface geometry 66 of the implant abutment connector 54, and has the bore 116 therethrough. The implant abutment connector can first be affixed to the jig or fixture, and then the partial blank affixed to the connector. Thus, the connector can be utilized to form multiple implant abutments from multiple partial blanks. Alternatively, the partial blank can be first affixed to the implant abutment connector, and then the connector affixed to the jig or fixture.

An electronic model of at least a portion of a patient's mouth, including an implant, can be obtained. For example, the patient's mouth can be electronically scanned at a dental office. The dentist or oral surgeon can implant the implant 30 prior to scanning the patient's mouth. Alternatively, an impression can be made at the dental office from which a physical dental model can be made and then electronically scanned. A representation of the implant can be inserted in the physical model prior to scanning the physical model. An electronic model 132 of a body 136 of the implant abutment 18 can be created, as shown at 140 in FIG. 9. The scanning can be accomplished with scanners as are known in the art. The electronic model can be created using computer hardware and software as known in the art. All scanning and modeling can be done in the dental office. Alternatively, some aspects can be done in the dental office, while other aspects can be done in a dental lab.

The millable blank portion 124 of the partial blank 106 can be milled based on the electronic model 132 to form the body 136 of the implant abutment 18, as shown at 144 in FIGS. 8a and 9. For example, the electronic model can be imported to the CNC milling machine. A first lateral side 148 of the millable blank portion 124 of the partial blank 106 is milled with the milling tool 46 of the milling machine based on the electronic model 132 of the body 136 to form a portion 152 of the body of the implant abutment in the partial blank, as shown at 156 in FIG. 8b. The partial blank 106 and the milling tool 48 can be caused to rotate with respect to one another. For example, the milling machine 22, either by program or command from an operator, can rotate the fixture 38 by 180 degrees. A second opposite lateral side 160 of the millable blank portion 124 of the partial blank 106 is milled with the milling tool based on the electronic model 132 of the body 136 to complete the body of the implant abutment 18 in the partial blank 106. Alternative, the first and second lateral sides of the millable blank portion of the partial blank can be milled simultaneously from opposite directions by two different milling tools, and without rotating the partial blank or the milling tool. The body 136 and the prefabricated implant abutment interface geometry 110 form the implant abutment 18 which is securable to an implant 30. The implant abutment 18 is removed from the implant abutment connector 54 by removing the fastener, indicated at 128 in FIG. 3.

Another or a subsequent electronic model of at least a portion of the patient's mouth, including the implant, can be obtained. For example, the patient's mouth can be electronically scanned at a dental office. Afterwords, the implant abutment can be secured to the physical dental model and then the physical model with the implant abutment can be scanned. An electronic model 164 of a crown 34 or coping can be created, as shown at 168 in FIG. 9. The scanning can be accomplished with scanners as are known in the art. The electronic model can be created using computer hardware and software as known in the art. The same computer hardware and software may be used for both the implant abutment and the crown or coping. Performing a second scan is believed to be superior to so called single scan systems wherein the implant abutment and the crown or coping are modeled together based on a single scan because of differences between the actual fit, shape and size of the milled implant abutment as opposed to the electronically modeled implant abutment.

A dental blank can be milled based on the electronic model 164 to form the crown 34 or coping. For example, the electronic model can be imported to the CNC milling machine. The same milling machine that was used to mill the implant abutment can be used to mill the crown or coping. Thus, the implant abutment connector and the dental blank can be interchanged. The jig 50 can be removed from the primary fixture 38, or the implant abutment connector 54 can be removed from the primary fixture 38b, or the secondary fixture can be removed from the milling machine and replaced with the primary fixture. A dental blank can be secured with respect to the milling machine, such as secured in the cavity of the primary fixture. The dental blank can be milled with the milling tool of the milling machine based on the electronic model of the crown or coping.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for fabricating a custom implant abutment, the method comprising:
a) securing an implant abutment connector with respect to a milling machine, the implant abutment connector having an implant interface geometry of an implant including a threaded bore;
b) securing a partial blank to the implant abutment connector, the partial blank having a prefabricated implant abutment interface geometry of an implant abutment matable with the implant interface geometry of the implant abutment connector, and having a bore therethrough, by mating the prefabricated implant abutment interface geometry of the partial blank with the implant interface geometry of the implant abutment connector and inserting a fastener through the bore of the partial blank and into securing engagement with the threaded bore of the implant abutment connector;
c) milling a first lateral side of the partial blank with a milling tool of the milling machine to form a portion of a body of an implant abutment in the partial blank;
d) milling a second opposite lateral side of the partial blank with the milling tool to complete the body of the implant abutment in the partial blank, the body and prefabricated implant abutment interface geometry forming an implant abutment securable to an implant; and
e) removing the implant abutment from the implant abutment connector by removing the fastener.

2. A method in accordance with claim 1, further comprising:
causing the partial blank and milling tool to rotate with respect to one another;

3. A method in accordance with claim 1, further comprising:
obtaining an electronic model of at least a portion of a patient's mouth including the implant; and
creating an electronic model of the body of the implant abutment, and wherein milling the first and second lateral sides of the partial blank is based on the electronic model of the body.

4. A method in accordance with claim 3, further comprising:
obtaining a subsequent electronic model of at least a portion of the patient's mouth including the implant with the implant abutment secured thereto;
creating an electronic model of a crown or coping; and
milling a dental blank based on the electronic model of the crown or coping.

5. A method in accordance with claim 1, wherein securing the implant abutment connector with respect to the milling machine further includes:
removably securing the implant abutment connector directly to a fixture of the milling machine, the fixture being configured to hold dental blanks.

6. A method in accordance with claim 1, wherein securing the implant abutment connector with respect to the milling machine further includes:
securing the implant abutment connector indirectly to a fixture of the milling machine, the fixture being configured to hold dental blanks, by securing the implant abutment connector to a jig that is coupled to the fixture.

7. A method in accordance with claim 1, wherein securing the implant abutment connector with respect to the milling machine further includes:
securing the implant abutment connector within a cavity of a fixture of the milling machine wherein the cavity is adapted to receive a dental blank.

8. A method in accordance with claim 1, wherein the implant interface geometry of the implant abutment connector includes an indentation; and wherein the prefabricated implant abutment interface geometry of the partial blank includes a protrusion.

9. A method in accordance with claim 1, wherein the implant abutment connector has a base end removably affixable directly to a fixture of the milling machine or affixable directly to a jig secured to the fixture of the milling machine.

10. A method in accordance with claim 1, further comprising milling a crown or coping in a dental blank with the same milling machine.

11. A method in accordance with claim 1, further comprising interchanging the implant abutment connector with a dental blank with respect to the milling machine.

12. A method for fabricating a custom implant abutment, the method comprising:
a) obtaining an electronic model of at least a portion of a patient's mouth including an implant;
b) creating an electronic model of a body of the implant abutment;
c) obtaining an implant abutment connector secured with respect to a milling machine, the implant abutment connector having an implant interface geometry of an implant including a threaded bore;
d) securing a partial blank to the implant abutment connector, the partial blank having a prefabricated implant abutment interface geometry of an implant abutment matable with the implant interface geometry of the implant abutment connector, and having a bore therethrough, by mating the prefabricated implant abutment interface geometry of the partial blank with the implant interface geometry of the implant abutment connector and inserting a fastener through the bore of the partial blank and into securing engagement with the threaded bore of the implant abutment connector;
e) milling a first lateral side of the partial blank with a milling tool of the milling machine based on the electronic model of the body to form a portion of the body of the implant abutment in the partial blank;
f) causing the partial blank and milling tool to rotate with respect to one another;
g) milling a second opposite lateral side of the partial blank with the milling tool based on the electronic model of the body to complete the body of the implant abutment in the partial blank, the body and prefabricated implant abutment interface geometry forming an implant abutment securable to an implant;
h) removing the implant abutment from the implant abutment connector by removing the fastener;
i) obtaining a subsequent electronic model of at least a portion of the patient's mouth including the implant with the implant abutment secured thereto;
j) creating an electronic model of a crown or coping;
k) securing a dental blank with respect to the milling machine; and
l) milling the dental blank with the milling tool of the milling machine based on the electronic model of the crown or coping.

13. A method in accordance with claim 12, further comprising:
securing the implant abutment connector with respect to the milling machine.

14. A method in accordance with claim 13, wherein securing the implant abutment connector with respect to the milling machine further includes:
removably securing the implant abutment connector directly to a fixture of the milling machine.

15. A method in accordance with claim 13, wherein securing the implant abutment connector with respect to the milling machine further includes:
securing the implant abutment connector indirectly to a fixture of the milling machine, the fixture being configured to hold dental blanks, by securing the implant abutment connector to a jig that is coupled to the fixture.

16. A method in accordance with claim 13, wherein the implant interface geometry of the implant abutment connector includes an indentation; and wherein the prefabricated implant abutment interface geometry of the partial blank includes a protrusion.

17. An implant abutment connector device for securing a partial blank, having a prefabricated implant abutment interface geometry of an implant abutment, to a fixture of a milling machine, the device comprising:
a) a base end removably affixable directly to the fixture or affixable directly to a jig coupled to the fixture;
b) an attachment end having an implant interface geometry matable with the prefabricated implant abutment interface geometry of the partial blank; and
c) a threaded bore capable of receiving a fastener through a bore of the partial blank and engaging the threaded bore to secure the partial blank to the attachment end of the implant abutment connector.

18. A device in accordance with claim 17, further comprising:
the fixture of the milling machine; and
the base end coupled to a cavity in the fixture adapted to receive a dental blank.

19. A device in accordance with claim 18, further comprising:
a jig coupled between the base end and the fixture; and
the jig coupled in the cavity in the fixture.

20. An implant abutment connector in combination with a partial blank configured to be secured to a fixture of a milling machine, the partial blank comprising a prefabricated implant abutment interface geometry of an implant abutment and a bore therethrough, the implant abutment connector comprising:
a) a base end removably affixable directly to the fixture of the milling machine or affixable directly to a jig coupled to the fixture of the milling machine;
b) an attachment end having an implant interface geometry mated with the prefabricated implant abutment interface geometry of the partial blank; and
c) a threaded bore with a fastener through the bore of the partial blank and engaging the threaded bore to secure the partial blank to the attachment end of the implant abutment connector.
